(19) United States
(12) Patent Application Publication
(10) Pub. No.: US 2024/0182634 A1
(43) Pub. Date: Jun. 6, 2024

(54) COATINGS, ADHESIVES AND ELASTOMERS UTILISING ACETOACETATE END-CAPPED POLYOL DERIVED FROM THERMOPLASTIC POLYESTERS

(71) Applicant: EQUUS UK TOPCO LTD, Weybridge, Surrey (GB)

(72) Inventor: Wilhelmus Jacobus Adrianus HONCOOP, Weybridge, Surrey (GB)

(73) Assignee: EQUUS UK TOPCO LTD, Weybridge, Surrey, EN (GB)

(21) Appl. No.: 18/551,956

(22) PCT Filed: Mar. 23, 2022
(86) PCT No.: PCT/EP2022/057610

§ 371 Date: Sep. 22, 2023

(30) Foreign Application Priority Data
Mar. 24, 2021 (GB) 2104083.7

(51) Int. Cl. C08G 63/48; C09D 167/08; C09J 167/08

(52) U.S. Cl. CPC C08G 63/48; C09D 167/08; C09J 167/08

(57) ABSTRACT

The present invention relates to an acetoacetate end-capped polyol comprising at least one residue of a polyol derived from a thermoplastic polyester, a polymer comprising the end capped polyol and the uses of such end-capped polyol containing materials. The invention also relates to methods of making a polymer composition comprising the acetoacetate end-capped polyol comprising at least one residue of a polyol derived from a thermoplastic polyester.

The present invention relates to an acetoacetate end-capped polyol comprising at least one residue of a polyol derived from a thermoplastic polyester, a polymer comprising the end capped polyol and the uses of such end-capped polyol containing materials. The invention also relates to methods of making a polymer composition comprising the acetoacetate end-capped polyol. In particular, the method of making the polymer composition may advantageously utilise a C-Michael addition reaction, the use of which is facilitated by the composition of the end-capped polyol.

The acetoacetate end-capped polyol of the present invention may be used in making alternatives to polyurethanes prepared from free isocyanates. Polyurethanes are extremely versatile materials and have been used in a wide variety of applications such as foam insulation, car seats, paint coatings, adhesives, sealants, tubing and cabling, elastomers, and abrasion resistant coatings. Polyurethanes may be used in protective coatings (e.g. applied to wood, metal, or plastic), in adhesives for rigid substrates (e.g. composites, metal), in adhesives for flexible substrates (textile, plastic film), in applications that require moisture-resistance (e.g. in products for outdoor use, or for product sealing e.g. in electronic devices), and in tough and wear-resistant elastomers.

Polyurethanes are also used in a wide variety of forms, for example non-cellular materials such as elastomers, and cellular materials such as low density flexible foams, high density flexible foams, and microcellular foams.

Polyurethanes, both in dispersion and non-dispersion forms, are also known to find use in adhesives, for example in hotmelt adhesives, moisture-cured adhesives and 2 component reactive adhesives. Such adhesives find use in, for example, the furniture industry.

Polyurethanes, both in cast thermoset and thermoplastic forms, are known to find use in composites. For example, a polyurethane may be used as a pre-matrix, fibre impregnating resin, and as binder resin of composites reinforced with fibres such as carbon, glass or polyester.

Polyurethane elastomers may be used in cabling, tubing, belting, sportswear (e.g. sports shoes, goggles, ski boots), films/sheets, automotive interiors (e.g. grips, armrests, consoles) and many other applications.

Typically, a polyurethane resin (and then subsequently the corresponding cured polyurethane polymer matrix product) may be made by reacting an isocyanate with a polyol. Although such polyurethanes prepared from isocyanates have their merits, they pose limitations when considering safety, environmental and health factors associated with use and handling of isocyanate. Toxicological profiles of monomeric isocyanates in the poly-isocyanate hardeners present in such polyurethanes have come under recent scrutiny, and changes driven by legislation has led the polyurethane manufacturing industry to search for new polymer resins and matrixes, particularly ones which do not require the presence of isocyanate, but where the performance of the polymer for its intended end use is not compromised. As such, new technologies are sought to produce polymers which provide beneficial polyurethane mechanical and chemical properties, but without using isocyanates. Such new technologies would be considered more sustainable.

Michael addition (or Michael reaction) chemistry is believed to offer an alternative sustainable process by which useful polymers could be prepared in the absence of isocyanate. Michael addition chemistry has been researched and used in some applications (Noomen, A., Prog.Org.Coat, 32, 137-142(1997)).

The key chemical components of a Michael addition system are electron deficient C═C double bonds, acidic C—H bond and a base catalyst strong enough to abstract the proton of this C—H bond which provides a nucleophilic carbanion that can add to the C═C double bond. A carbon-carbon link is thus formed between the two molecules via reaction of the nucleophilic carbanion provided. The second proton of the donor molecule is available for a similar, subsequent, reaction.

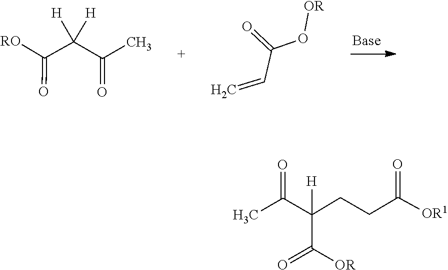

The present invention seeks to provide an improved polyol which may find utility in a polymer composition so that the problems associated with isocyanate derived polyurethanes can be overcome.

Accordingly, the present invention provides an acetoacetate end-capped polyol comprising at least one residue of a polyol derived from virgin thermoplastic polyester, recycled thermoplastic polyester and mixtures thereof and optionally one or more of,
a) at least one dimer fatty residue selected from a dimer fatty acid residue, a dimer fatty diol residue and a dimer fatty diamine residue; and
b) at least one residue of a linear or branched C2 to C36 diacid or diol.

In an alternative embodiment, the present invention provides a polymer composition comprising said acetoacetate end-capped polyol.

The present invention also provides a method of making a polymer composition comprising reacting said acetoacetate end-capped polyol with an acrylate to form:
(i) a polymer resin; or
(ii) a polymer matrix.

The present invention further provides the use of a polyol of the first aspect to form a polymer composition.

Additionally, the present invention provides a coating comprising said acetoacetate end-capped polyol or said polymer composition comprising said acetoacetate end-capped polyol.

It will be understood that any upper or lower quantity or range limit stated herein may be independently combined.

It will be understood by the skilled person that, when describing the number of carbon atoms in a substituent group (e.g. ‘C1 to C6’), the number refers to the total number of carbon atoms present in the substituent group, including any present in any branched groups. Additionally, when describing the number of carbon atoms in, for example fatty acids, this refers to the total number of carbon atoms including the one at the carboxylic acid, and any present in any branch groups.

Many of the chemicals which may be used to produce the polyol or polymer composition of the present invention are obtained from natural sources. Such chemicals typically include a mixture of chemical species due to their natural origin. Due to the presence of such mixtures, various parameters defined herein can be an average value and may be non-integral.

The term ‘polyol’ is well known in the art and refers to a molecule comprising more than one hydroxyl group.

The term ‘polyester’ as used herein refers to a molecule or group with more than one ester bond.

The term ‘dimer fatty residue’ as used herein, unless otherwise defined, refers to a residue of a dimer fatty acid (also referred to as a dimer fatty diacid) or a residue of a dimer fatty acid derivative such as a dimer fatty diol or a dimer fatty diamine.

The term ‘functionality’ as used herein with regard to a molecule or part of a molecule refers to the number of functional groups in that molecule or part of a molecule. A ‘functional group’ refers to a group in a molecule which may take part in a chemical reaction. For example, a carboxylic acid group, a hydroxyl group and an amine group are all examples of functional groups. For example, a diacid (with two carboxylic acid groups) and a diol (with two hydroxyl groups) both have a functionality of 2 and a triacid and triol both have a functionality of 3.

The term ‘dimer fatty acid’ (also referred to as dimer fatty diacid) is well known in the art and refers to the dimerisation products of mono- or polyunsaturated fatty acids and/or esters thereof. The related term trimer fatty acid similarly refers to trimerisation products of mono- or polyunsaturated fatty acids and/or esters thereof.

The term polyol derived from virgin thermoplastic polyester, recycled thermoplastic polyester and mixtures is well known in the art and refers to the product from heating a thermoplastic polyester with a glycol to give a digested polyol.

The present invention provides an acetoacetate end-capped polyol comprising at least one residue of a polyol derived from virgin thermoplastic polyester, recycled thermoplastic polyester and mixtures thereof.

The acetoacetate end-capped polyol of the present invention optionally, and preferably, comprises:
a) at least one dimer fatty residue selected from a dimer fatty acid residue, a dimer fatty diol residue and a dimer fatty diamine residue;
and/or
b) at least one residue of a linear or branched C2 to C36 diacid or diol.

As such, the present acetoacetate end-capped polyol can be considered to comprise a minimum of two components, one being the acetoacetate end-cap component and the other being the at least one residue of a polyol derived from virgin thermoplastic polyester, recycled thermoplastic polyester and mixtures thereof as defined above. Alternatively, in some embodiments, the acetoacetate end-capped polyester polyol comprises three components, one being the acetoacetate end-cap component and the other two being the at least one residue of a polyol derived from virgin thermoplastic polyester, recycled thermoplastic polyester and mixtures thereof, and a) or b) as defined above, the presence of b) being particularly preferred. Additionally, in a further alternative embodiment, the acetoacetate end-capped polyester polyol comprises four components, one being the acetoacetate end-cap component and the other three being the at least one residue of a polyol derived from virgin thermoplastic polyester, recycled thermoplastic polyester and mixtures thereof, and a) and b) as defined above.

Suitably, the polyol prior to end capping may be a diol, triol, tetrol, pentol or hexol. Preferably the polyol prior to end capping is a diol, triol or tetrol, more preferably a diol or triol. Most preferably, prior to end capping the polyol is a diol.

The polyol may comprise at least 2 ester bonds, preferably at least 3 ester bonds, more preferably at least 4 ester bonds, even more preferably at least 5 ester bonds.

The polyol may comprise at most 10 ester bonds, preferably at most 8 ester bonds, more preferably at most 7 ester bonds.

The polyol may be a polyester.

The polyol may comprise at least one ether bond. The polyol may be a polyester ether.

In a less preferred embodiment the polyol may comprise at least one amide bond.

In a less preferred embodiment the polyol may be a polyester amide.

In a less preferred embodiment the polyol may be a polycarbonate.

The acetoacetate end-capped polyol may have a molecular weight (number average) of at least 500, preferably at least 800, more preferably at least 1000, even more preferably at least 1500, especially preferably at least 1800.

The acetoacetate end-capped polyol may have a molecular weight (number average) of at most 5000, preferably at most 4000, more preferably at most 3000, even more preferably at most 2500, especially preferably at most 2200.

The acetoacetate end-cap component of the acetoacetate end-capped polyol may be selected from one or more of the following: methyl acetoacetate, ethyl acetoacetate, tert-butyl acetoacetate, isopropyl acetoacetate, isobutyl acetoacetate and ketene derivatives. Preferably the acetoacetate end-cap is methyl acetoacetate.

The acetoacetate end-capped polyol may comprise at least 10 wt % acetoacetate end-cap, preferably at least 40 wt %, more preferably 50 wt %. The acetoacetate end-capped polyol may comprise at most 95 wt % acetoacetate end-cap, preferably 85 wt %, and more preferably at most 75 wt %.

The polyol comprises at least one residue of polyol derived from virgin thermoplastic polyester, recycled thermoplastic polyester and mixtures. These polyols will now be described in more detail.

Polyols derived from virgin thermoplastic polyester, recycled thermoplastic polyester and mixtures are well known in the art and refers to the product from heating a thermoplastic polyester with a glycol to give a digested polyol.

Thermoplastic polyesters suitable for use in making polyester polyols are well known in the art. The virgin thermoplastic polyesters are condensation polymers produced from the reaction of glycols and aromatic dicarboxylic acids or acid derivatives. Recycled thermoplastic polyester is commonly derived from post-consumer virgin thermoplastic polyester waste, and previously recycled thermoplastic polyester waste can also be utilised in the present invention. Examples of suitable thermoplastic polyesters include: polyethylene terephthalate (PET), polybutylene terephthalate (PBT), polytrimethylene terephthalate (PTT), glycol-modified polyethylene terephthalate (PETG), copolymers of terephthalic acid and 1,4-cyclohexanedimethanol (PCT), PCTA (an isophthalic acid-modified PCT), polyhydroxy alkanoates (e.g., polyhydroxybutyrate), copolymers of diols with 2,5-furandicarboxylic acid or dialkyl 2,5-furandicarboxylates (e.g., polyethylene furanoate), copolymers of 2,2,4,4-tetramethyl-1,3-cyclobutanediol with isophthalic acid, terephthalic acid or orthophthalic derivatives, dihydroferulic acid polymers and the like. Further examples of polyester thermoplastics are described in Modern Polyesters: Chemistry and Technology of Polyesters and Copolyesters, J. Scheirs and T. Long, eds., Wiley Series in Polymer Science, 2003, John Wiley & Sons, Ltd. Hoboken, NJ. Other examples of thermoplastic polyesters may be found in Chapters 18-20 of Handbook of Thermoplastics, O. Olabisi, ed., 1997, Marcel Dekker, Inc. New York. For more examples of suitable thermoplastic polyesters, see U.S. Pat. Appl. Publ. No. 2009/0131625, the teachings of which are incorporated herein by reference.

Furthermore, polyol derived from polyethylene terephthalate is particularly preferred in the present invention, especially recycled polyethylene terephthalate (rPET), virgin PET, and mixtures thereof. rPET suitable for use in making the inventive polyester polyols can come from a variety of sources. The most common source is the post-consumer waste stream of PET from plastic bottles or other containers. The rPET can be colorless or contain dyes (e.g., green, blue, or other colors) or be mixtures of these. A minor proportion of organic or inorganic foreign matter (e.g., paper, other plastics, glass, metal, etc.) can be present. A desirable source of rPET is “flake” rPET, from which many of the common impurities present in scrap PET bottles have been removed in advance. Another desirable source of rPET is pelletized rPET, which is made by melting and extruding rPET through metal filtration mesh to further remove particulate impurities. Because PET plastic bottles are currently manufactured in much greater quantity than any recycling efforts can match, scrap PET will continue to be available in abundance. The present invention allows these scrap PET to enjoy a wider utility in products made from the original PET material, as the polyol is able to undergo new reactions and form polymers with differing properties to those of the original PET; straight recycling of the PET to rPET does not allow for such a divergence in product properties to be realised.

Glycols suitable for use suitable in making polyester polyols are also well known in the art. By “glycol,” in this context we mean a linear or branched, aliphatic or cycloaliphatic compound or mixture of compounds having two or more hydroxyl groups. However, other functionalities, particularly ether or ester groups, may be present in the glycol. In preferred glycols, two of the hydroxyl groups are separated by from 2 to 10 carbons, preferably 2 to 5 carbons. Suitable glycols include, for example, ethylene glycol, propylene glycol, 1,3-propanediol, 1,2-butylene glycol, 1,3-butylene glycol, 1,4-butanediol, 2-methyl-1,3-propanediol, pentaerythritol, sorbitol, neopentyl glycol, glycerol, trimethylolpropane, 2,2,4,4-tetramethyl-1,3-cyclobutanediol, 3-methyl-1,5-pentanediol, 1,4-cyclohexanedimethanol, 1 ,3-cyclohexanedimethanol, bisphenol A ethoxylates, diethylene glycol, dipropylene glycol, triethylene glycol, 1,6-hexanediol, tripropylene glycol, tetraethylene glycol, polyethylene glycols having a number average molecular weight up to about 400 g/mol, block or random copolymers of ethylene oxide and propylene oxide, and the like. Propylene glycol is particularly preferred. Most preferably, the glycol is a recycled glycol, especially recycled propylene glycol. Propylene glycol recovered from used deicing fluids is one example of a source of used glycol that may be recovered and made and available as recycled propylene glycol; as such a particularly preferred embodiment the polyol may be produced from rPET digested in the presence of recycled propylene glycol, to produces a polyol from 100% recycled materials.

As stated above, methods of preparing the polyols from thermoplastic polyester are known, via heating a thermoplastic polyester with a glycol to give a digested polyol. However, a brief summary of the method of preparation is now described. The thermoplastic polyester and glycol are heated, optionally in the presence of a catalyst, to give a digested intermediate. The digested intermediate will commonly be a mixture of glycol reactant, glycol(s) generated from the thermoplastic polyester, terephthalate oligomers, and other glycolysis products. For example, when PET or rPET is the thermoplastic polyester, the digested intermediate will include a mixture of glycol reactant, ethylene glycol (generated from the PET or rPET), bis(2-hydroxyalkyl) terephthalate (“BHAT”), higher PET oligomers, and other glycolysis products. Similar digested mixtures in various forms have been made and characterized previously (see, e.g., D. Paszun et al., Ind. Eng. Chem. Res. 36 (1997) 1373 and N. Ikladious, J. Elast. Plast. 32 (2000) 140). Heating is advantageously performed at temperatures within the range of 80° C. to 260° C. In one aspect, when the thermoplastic polyester is polyethylene terephthalate, the digested intermediate comprises glycols and a terephthalate component. The terephthalate component preferably comprises, (as measured by gel permeation chromatography using ultraviolet detection), 45 to 70 wt. % of bis(hydroxyalkyl)terephthalates. In a preferred aspect, the terephthalate component further comprises 20 to 40 wt. % of terephthalate dimers. In another preferred aspect, the terephthalate component of the digested intermediate comprises 45 to 65 wt. % of bis(hydroxyalkyl)terephthalates, 20 to 35 wt. % of terephthalate dimers, and 5 to 15 wt. % of terephthalate trimers. In another preferred aspect, the terephthalate component comprises 50 to 60 wt. % of bis(hydroxyalkyl)-terephthalates, 25 to 30 wt. % of terephthalate dimers, and 8 to 12 wt. % of terephthalate trimers.

The component,
a) at least one dimer fatty residue selected from a dimer fatty acid residue, a
dimer fatty diol residue and a dimer fatty diamine residue, of the acetoacetate end-capped polyol, will now be described in more detail.

Generally, the at least one dimer fatty residue may include any of the features or preferences described herein with regard to dimer fatty acids, dimer fatty diols or dimer fatty diamines as detailed below.

Suitably, the at least one dimer fatty residue may be saturated or unsaturated. However, preferably the at least one dimer fatty residue is saturated.

The dimer fatty residue is fatty in nature and this may increase the hydrophobicity of the polyol. The presence of the dimer fatty residue may render the polyol more amorphous, non-crystalline or substantially non-crystalline. The amorphous nature of the polyol may increase the flexibility and/or decrease the tensile strength of a polymer matrix comprising the polyol, as further described below.

The acetoacetate end-capped polyol may comprise at least 5 wt % dimer fatty residue, preferably at least 10 wt %. The polyol may comprise at most 90 wt % dimer fatty residue, preferably 85 wt % dimer fatty residue, and more preferably at most 80 wt %.

The at least one dimer fatty residue selected may be a dimer fatty acid residue.

Suitably, the acetoacetate end-capped polyol may comprise at least 5 wt % dimer fatty acid residue, preferably at least 10 wt %. The polyol may comprise at most 30 wt % dimer fatty acid residue, preferably at most 20 wt %.

Dimer fatty acids are described in T. E. Breuer, ‘Dimer Acids’, in J. I. Kroschwitz (ed.), Kirk-Othmer Encyclopaedia of Chemical Technology, 4th Ed., Wily, New York, 1993, Vol. 8, pp. 223-237. They are prepared by polymerising fatty acids under pressure, and then removing most of the unreacted fatty acid starting materials by distillation. The final product usually contains some small amounts of mono fatty acid and trimer fatty acids but is mostly made up of dimer fatty acids. The resultant product can be prepared with various proportions of the different fatty acids as desired.

The ratio of dimer fatty acids to trimer fatty acids can be varied, as is known to the person skilled in the art, by modifying the processing conditions and/or the unsaturated fatty acid feedstock. The dimer fatty acid may be isolated in substantially pure form from the product mixture, using purification techniques known in the art, or alternatively a mixture of dimer fatty acid and trimer fatty acid may be employed.

The dimer fatty acids or dimer fatty residues used in the present invention are preferably derived from the dimerisation products of C10 to C30 fatty acids, more preferably C12 to C24 fatty acids, particularly C14 to C22 fatty acids, further preferably C16 to C20 fatty acids, and especially C18 fatty acids. Thus, the resulting dimer fatty acids preferably comprise in the range from 20 to 60, more preferably 24 to 48, particularly 28 to 44, further preferably 32 to 40, and especially 36 carbon atoms.

Suitably, the fatty acids, from which the dimer fatty acids are derived, may be selected from linear or branched unsaturated fatty acids, and linear fatty acids are preferred. The unsaturated fatty acids may be selected from fatty acids having either a cis/trans configuration and may have one or more than one unsaturated double bond. However, monounsaturated fatty acids are particularly preferred. Most preferably, the fatty acids are linear monounsaturated fatty acids.

Suitably, the dimer fatty acids may be non-hydrogenated, hydrogenated, or partially hydrogenated. A hydrogenated dimer fatty residue (whether from a diacid, diol or diamine) may have better oxidative or thermal stability which may be desirable in a polymer comprising the polyol, as such preferably the dimer fatty acid is hydrogenated or partially hydrogenated.

Suitable dimer fatty acids are preferably derived from (i.e. are the dimer equivalents of) the dimerisation products of oleic acid, linoleic acid, linolenic acid, palmitoleic acid, or elaidic acid. In particular, suitable dimer fatty acids are preferably derived from oleic acid.

The dimer fatty acids may be dimerisation products of unsaturated fatty acid mixtures obtained from the hydrolysis of natural fats and oils, e.g. sunflower oil, soybean oil, olive oil, rapeseed oil, cottonseed oil, or tall oil.

The molecular weight (weight average) of the dimer fatty acid is preferably in the range from 450 to 690, more preferably 500 to 640, particularly 530 to 610, and especially 550 to 590.

Furthermore, in addition to the dimer fatty acids, dimerisation usually results in varying amounts of trimer fatty acids (so-called “trimer”), oligomeric fatty acids, and residues of monomeric fatty acids (so-called “monomer”), or esters thereof, being present. The amount of monomer can, for example, be reduced by distillation. Since distillation of the dimer fatty acid product will increase production costs the presence of these optional dimerisation reaction products is tolerated, however, purification by distillation of the dimer fatty acid may be preferred for some niche applications.

Suitably, the trimer fatty acids are preferably derived from the trimerisation products of the materials mentioned with regard to the dimer fatty acids, and are preferably trimers of C10 to C30, more preferably C12 to C24, particularly C14 to C22, further preferably C16 to C20 fatty acids, and especially C18 fatty acids. Thus, the trimer fatty acids preferably contain in the range from 30 to 90, more preferably 36 to 72, particularly 42 to 66, further preferably 48 to 60, and especially 54 carbon atoms.

The molecular weight (weight average) of the trimer fatty acids is preferably in the range from 750 to 950, more preferably 790 to 910, particularly 810 to 890, and especially 830 to 870.

Additionally, or alternatively, tetramer fatty acids and higher oligomers (hereinafter both referred to as oligomeric acids) may be formed during production of the dimer fatty acid.

Such oligomeric acids may therefore also be present in the dimer fatty acids used in the present invention, in combination with trimer fatty acids and/or dimer fatty acids and/or mono fatty monoacids, as alluded to above.

The oligomeric acids are preferably oligomers, containing 4 or more units derived from C10 to C30, more preferably C12 to C24, particularly C14 to C22, and especially C18 fatty acids. The molecular weight (weight average) of the oligomeric acid is suitably greater than 1000, preferably in the range from 1200 to 1800, more preferably 1300 to 1700, particularly 1400 to 1600, and especially 1400 to 1550.

The dimer fatty acid used in the present invention preferably may have a dimer fatty acid (or dimer) content of greater than 60 wt. %, more preferably greater than 70 wt. %, particularly greater than 80 wt. %, and especially greater than 85 wt. %. Most preferably, the dimer content of the dimer fatty acid is in the range from 90 wt. % to 99 wt. %.

In an alternative embodiment, the dimer fatty acid preferably has a dimer fatty acid (or dimer) content in the range from 70 wt. % to 96 wt. %. This may be applicable in particular for two component or cross-linked systems.

Additionally, or alternatively, particularly preferred dimer fatty acids may have a trimer fatty acid (or trimer) content of less than 40 wt. %, more preferably less than 30 wt. %, particularly less than 20 wt. %, and especially less than 15 wt. %. The trimer fatty acid content may be less than 4 wt. %.

Furthermore, the dimer fatty acid preferably comprises less than 10 wt. %, more preferably less than 5 wt. %, particularly less than 4 wt. %, and especially less than 2.5 wt. % of mono fatty monoacid (or monomer).

All of the above weight percentage values are based on the total weight of the polymerised fatty acids and mono fatty acids present in the dimer fatty acid.

The at least one dimer fatty residue selected may be a dimer fatty diol residue.

A suitable dimer fatty diol may be formed by hydrogenation of the corresponding dimer fatty acid. A dimer fatty acid (or dimer fatty diacid) may be converted to a dimer fatty diol as is known in the art. A dimer fatty diol may have properties as described herein with regard to a dimer fatty acid (or dimer fatty diacid) except that the acid groups in the dimer fatty acid are replaced with hydroxyl groups in the dimer fatty diol. In a similar manner, a trimer fatty triacid may be converted to a trimer fatty triol which may have properties as described herein with regard to a trimer fatty triacid. As such, the same preferred embodiments detailed herein in relation to the dimer fatty acid may apply to corresponding preferred embodiments of the dimer fatty diol residue component of the polyol.

Suitably, the polyol prior to being end-capped may comprise at least 50 wt % dimer fatty diol residue, preferably at least 60 wt %. The polyol may comprise at most 90 wt % dimer fatty diol residue, preferably at most 80 wt %. These amounts of dimer fatty residue may provide a suitable amount of hydrophobicity and/or amorphousness to the polyol without an excessive decrease in tensile strength or hardness of a polymer matrix comprising the polyol.

Suitably, the acetoacetate end-capped polyol may comprise at least 5 wt % dimer fatty diol residue, preferably at least 10 wt %. The polyol may comprise at most 30 wt % dimer fatty diol residue, preferably at most 20 wt %.

The dimer fatty diol may be hydrogenated. The dimer fatty diol may be non-hydrogenated.

Additionally, or alternatively, the polyol may comprise at least one dimer fatty diamine residue, such that the at least one dimer fatty residue selected may be a dimer fatty diamine residue. However, this embodiment is less preferred, and the polyol may comprise no dimer fatty diamine residue, and hence no associated amine groups in component a) of the polyol.

The component,
b) at least one residue of a linear or branched C2 to C36 diacid or diol,
of the acetoacetate end-capped polyol, will now be described in more detail.

Preferably the at least one residue of a C2 to C36 diacid or diol has at least 2 functional groups selected from a carboxylic acid group, a hydroxyl group, and mixtures thereof. In some embodiments, the diacid or diol preferably has only 2 functional groups selected from a carboxylic acid group, a hydroxyl group, and mixtures thereof.

The polyol prior to being end-capped may comprise at least 10 wt % of component b), preferably at least 15 wt %, more preferably at least 20 wt %. The polyol prior to being end-capped may comprise at most 50 wt % of b), preferably at most 40 wt %. It will be understood that the level of component b) in the end-capped polyol will be least 0.10 wt %, preferably at least 0.15 wt %, and more preferably at least 0.20 wt %. Furthermore, it will be understood that the level of component b) in the end-capped polyol may comprise at most 15 wt % dimer fatty diol residue, preferably at most 8 wt %. These amounts of b) may provide a suitable amount of crystallinity to the polyol without an excessive decrease in flexibility of a polymer matrix comprising the polyol.

It should be understood that component b) is a non-dimeric diacid or diol and is distinct to the dimer fatty acid and diols described above for component a).

Suitable non-dimeric diacids may be aliphatic or aromatic (such as phthalic acid, isophthalic acid and terephthalic acid), and include dicarboxylic acids and their esters, preferably alkyl esters, thereof.

Preferably the polyol comprises at least two residues of a linear or branched C2 to C36 diacid or diol, and in some embodiments may comprise at least three residues of a linear or branched C2 to C36 diacid or diol, each independently selected from the preferred embodiments detailed below. The inclusion of more than one type of one residue of a linear or branched C2 to C36 diacid or diol will allow the physical properties of a polymer comprising the polyol to be tailored to its specific end use.

In one preferred embodiment b) comprises at least one residue of a linear or branched C6 to C36 dicarboxylic acid or diol. The presence of b) in the polyol may make the polyol more crystalline due to the long aliphatic carbon chain present in the at least one residue of a C6 to C36 linear or branched dicarboxylic acid or diol. The increased crystallinity may increase the tensile strength and/or hardness of a polymer matrix comprising the polyol. It may also increase the green strength of an adhesive formed from such a polyol containing polymer. The at least one residue of a C6 to C36 linear or branched diacid may include the esters thereof, preferably alkyl esters and more preferably dimethyl esters.

The at least one residue of a C6 to C36 linear or branched dicarboxylic acid or diol may be linear. It may comprise terminal carboxyl or hydroxyl groups, wherein the terminal carboxyl or hydroxyl groups are bridged by an alkyl group, or an alkenyl group.

The at least one residue of a C6 to C36 linear or branched dicarboxylic acid or diol may be branched. The at least one residue of a C6 to C36 linear or branched diacid or diol may comprise at least one methyl branch. The at least one residue of a C6 to C36 linear or branched diacid or diol may comprise at least one ethyl branch.

The at least one residue of a C6 to C36 linear or branched dicarboxylic acid or diol may be saturated or unsaturated, preferably saturated.

Preferably the C6 to C36 dicarboxylic acid or diol is a linear dicarboxylic acid.

The C6 to C36 dicarboxylic acid or diol may preferably be a C18 to C26 dicarboxylic acid or diol, and more preferably a C18 or C26 dicarboxylic acid or diol. The C6 to C36 dicarboxylic acid or diol may preferably be a C18 dicarboxylic acid. The C6 to C36 dicarboxylic acid or diol may preferably be a C26 dicarboxylic acid.

The C6 to C36 diacid or diol may be derived from a C6 to C36 diacid or dialkyl ester which is obtained by a metathesis reaction, preferably a self-metathesis reaction. The metathesis reaction may occur in the presence of a catalyst. Suitable metathesis catalysts are disclosed in WO 2008/065187 and WO 2008/034552, and these documents are incorporated herein by reference.

Additionally, or alternatively, it is particularly preferred that component b) comprises at least one residue of a linear dicarboxylic acid having a carbon chain in the range from 4 to 12 carbon atoms, and more preferably, b) comprises at least one residue of a linear dicarboxylic acid having 6 to 10 carbon atoms. Particularly preferred examples include adipic acid, glutaric acid, succinic acid, pimelic acid, suberic acid, azelaic acid, sebacic acid, heptane dicarboxylic acid, octane dicarboxylic acid, nonane dicarboxylic acid, decane dicarboxylic acid, undecane dicarboxylic acid, and dodecane dicarboxylic acid. Azelaic acid is particularly preferred. More especially, this embodiment is particularly preferred where component b) comprises at least two or more residues of said C2 to C36 diacid or diols.

Alternatively, preferably, b) may comprise at least one residue of a diol having from 2 to 10 carbon atoms, more preferably from 5 to 8 carbon atoms. This embodiment is particularly preferred where component b) comprises at least two or more residues of the C2 to C36 diacid or diols.

Suitable non-dimeric diols may be independently selected from straight chain aliphatic diols or branched aliphatic diols, or a combination thereof.

Suitable non-dimeric diols include straight chain aliphatic diols such as ethylene glycol, diethylene glycol, 1,3-propylene glycol, dipropylene glycol, 1,4-butylene glycol, 1,6-hexylene glycol (also known as hexanediol) and mixtures thereof, branched diols such as neopentyl glycol, 3-methyl pentane glycol, 1,2-propylene glycol and mixtures thereof, and cyclic diols such as 1,4-bis(hydroxymethyl)cyclohexane and 1,4-cyclohexane-dimethanol and mixtures thereof. Hexanediol is particularly preferred.

Straight chain aliphatic diols may be independently selected from ethylene glycol, diethylene glycol, 1,3-propylene glycol (better known as 1,3-propanediol), 1,4-butanediol and 1,6-hexanediol. Such materials are particularly preferred.

Branched aliphatic diols may be independently selected from 1,2-propylene glycol, 1,2-butanediol, 2,3-butanediol, and 1,3-butanediol.

The component b) may comprises at least one residue of a polyether diol, for example polyethylene glycol, polypropylene glycol or polytetrahydrofuran (also known as polytetramethylene ether glycol or PTMEG). The PTMEG may have a molecular weight (number average) of from 200 to 2000, preferably from 200 to 1000, more preferably from 200 to 500. This embodiment is particularly preferred where component b) comprises at least two or more residues of the C2 to C36 diacid or diols.

Component b) may comprise at least one residue of a polyol having a hydroxyl function greater than 2. Such polyols may include glycerol, pentaerythritol, or trimethylolpropane.

The component b) is preferably derived from a renewable and/or bio-based source and is most preferably a vegetable derivative. The level of the renewable carbon content of b) may be determinable by ASTM D6866 as a standardised analytical method for determining the bio-based content of a sample using ¹⁴C radiocarbon dating. ASTM D6866 distinguishes carbon resulting from bio-based sources from those derived from fossil-based sources. Using this standard, a percentage of carbon from renewable sources can be calculated from the total carbon in a tested sample. Suitably, component b) may have a renewable carbon content of at least 50 wt % when determined using ASTM D6866, preferably at least 65 wt %, more preferably at least 80 wt %.

Suitably, the weight ratio of a) to b) in the polyol may be in the range 100:0 to 0:100, preferably in the range 45:55 to 15:85. The weight 5% of a) in the acetoacetate end-capped polyol may be at least the weight 95% of b). These relative amounts of a) and b) in the acetoacetate end-capped polyester polyol may provide an advantageous balance of flexibility, tensile strength, hardness, and hydrolysis resistance in a polymer matrix formed from the polyester polyol,

The polyol prior to end capping preferably has a hydroxyl value (measured as described herein) in the range from 10 to 150, more preferably 30 to 140, particularly preferably 60 to 120, and especially preferably 75 to 110 mgKOH/g.

In addition, the polyol prior to end capping preferably has an acid value (measured as described herein) of less than 2, more preferably less than 1.7, particularly preferably less than 1.3, and especially preferably less than 1.0 mgKOH/g.

Additionally, or alternatively, the present invention provides a polymer composition comprising the acetoacetate end-capped polyol as described above. Such polymer compositions may have one or more desired physical properties and be particularly suited to their intended end use.

Suitably the polymer composition may be a resin (i.e. pre-cured polymeric material, in an intermediate form) or a polymer matrix (i.e. post-cured polymeric material, in its final form). As such, the polymer composition can be considered to embrace two distinct embodiments, the first being a resin and the second being a polymer matrix. There is a large amount of overlap between the two polymer composition embodiments, since additives necessary for intended use or processing of a polymer matrix final product may be introduced during manufacture of the polymer resin for ease of post-processing or handling. As such, embodiments below which refer to the “polymer composition” apply equally to the polymer resin and polymer matrix embodiments.

The polymer composition may be provided as a resin, and subsequently the resin may be converted to a polymer matrix via curing. The difference between the polymer resin and polymer matrix, as will be appreciated by the skilled person, is that cross-linking of the polymer chains will be present in the polymer matrix. Curing to cross-link the polymer chains may be achieved by any suitable means, although preferred means will be described further below.

The dimer fatty residue content of the polymer composition is preferably in the range from 5 to 50%, more preferably 8 to 40%, particularly 12 to 30%, and especially 15 to 20% by weight.

The polymer composition is preferably derived from renewable and/or bio-based sources. The level of this may be determinable by ASTM D6866 as briefly described herein. Preferably, the polymer composition has a renewable carbon content of at least 50% when determined using ASTM D6866. More preferably, at least 65%. Most preferably, at least 80%.

It is a particular advantage of the polymer composition of the present invention that it is isocyanate free. As such, the polymer composition does not contain isocyanate. The polymer composition is substantially free from isocyanate.

Preferably the polymer composition is the reaction product of the acetoacetate end capped polyol described above and an acrylate. As such the polymer composition comprises acetoacetate end-capped polyol and an acrylate.

Suitably, the acrylate may be selected from one or more of an acrylate, a polyfunctional acrylate, an oligomeric acrylate, or derivatives thereof.

Preferably the acrylate is provided by an oligomeric acrylate or derivative thereof. Particular preferred oligomeric acrylates are urethane acrylates and epoxy acrylates. Such oligomeric acrylates may preferably be oligomeric acrylates resins, as further detailed below. Commercially available oligomeric acrylate resins include Photomer® from IGM Resins, Laromer® from BASF, Ebecryl® from Allnex, amongst others.

Preferable polyfunctional acrylates or derivatives thereof have a functionality equal to or greater than two. Suitably, the polyfunctional acrylate derivative may be selected from the group consisting of any monomeric or oligomeric molecule possessing acrylate, methacrylate, ethacrylate, and combinations thereof.

Preferably, the acrylate derivative may be selected from the group consisting of hexafunctional urethane acrylates, dipentaerythritol pentaacrylate, ethoxylated pentaerythritol tetraacrylate, di-trimethylolpropane tetraacrylate, pentaerythritol triacrylate, trimethylolpropane triacrylate, ethoxylated trimethylolpropane triacrylate, butanediol diacrylate, tripropylene glycol diacrylate, trimethylolpropane trimethacrylate, difunctional urethane acrylates, tetraacrylate monomer, polyester acrylate oligomers, and combinations thereof.

In one particularly preferred embodiment the polyfunctional acrylate derivative is a urethane acrylate oligomer.

In an alternative particularly preferred embodiment, the acrylate is a polyfunctional acrylate oligomer selected from an oligomeric epoxy acrylate resin or oligomeric polyether acrylate resin or oligomeric polyester acrylate or combinations thereof.

The polymer composition may optionally contain other additives such as blowing agents, catalysts, pigments, fillers, surfactants, and stabilisers.

The polymer composition may optionally comprise blowing agents, which may include water, fluorocarbons such as trichlorofluoromethane, dichlorodifluoromethane and trichlorodifluoroethane, or mixtures thereof.

The polymer composition may optionally comprise a catalyst. The catalyst may be present in a polymer resin to assist in post-processing or may be present in a polymer matrix due to being immobilised in the polymer matrix during processing. Such catalysts tend to be homogeneous catalysts. A preferred homogeneous catalyst is a salt of a basic anion group. Examples of useful cations include inorganic cations, preferably alkaline or alkaline earth metal cations, more preferably K+, Na+ and Li+, or organic cations like tetra-alkylammonium and tetra-alkylphosphonium salts, but also cations that do have a proton but are extremely non-acidic, for example protonated species of strongly basic organic bases as e.g. 1,8-Diazabicyclo[5.4.0]undec-7-ene (DBU), 1,5-Diazabicyclo[4.3.0] non-5-ene (DBN) or tetra-methylguanidine.

The polymer composition may optionally comprise surfactants. Preferred surfactants may include one or more of the following, silicone surfactants such as dimethylpolysiloxane, polyoxyalkylene polyol-modified dimethylpolysiloxane and alkylene glycol-modified dimethylpolysiloxane; and/or anionic surfactants such as fatty acid salts, sulphuric acid ester salts, phosphoric acid ester salts and sulphonates.

The polymer composition may optionally comprise a stabiliser. Suitably, the stabiliser may be selected from a radical scavenger, antioxidant or ultra violet light absorbing agent. Suitable stabilisers can be selected by the skilled person dependent upon the intended end use of the polymer composition. Examples of the stabilisers include hindered phenol radical scavengers such as dibutylhydroxytoluene, pentaerythrityl-tetrakis[3-(3,5-di-t-butyl-4-hydroxyphenyl) propionate] and isooctyl-3-(3,5-di-t-butyl-4-hydroxyphenyl)propionate; antioxidants such as phosphorous acid compounds such as triphenylphosphite, triethylphosphite and triphenylphosphine; ultraviolet absorbing agents such as 2-(5-methyl-2-hydroxyphenyl)benzotriazole and a condensation product of methyl-3-[3-t-butyl-5-(2H-benzotriazole-2-yl)-4-hydroxyphenyl]propionate and polyethylene glycol.

The polymer composition may optionally comprise a pigment or dye. Suitable pigments include inorganic pigments such as transition metal salts; organic pigments such as azo compounds; and carbon powder.

The polymer composition may optionally comprise a filler. Suitable fillers include inorganic fillers such as clay, chalk, and silica.

The polymer composition may optionally comprise a chain extender component. The chain extender component may be in the form of a chain extender composition. The chain extender composition is preferably prepared by simple pre-mixing of, for example, the chain extender, an acrylate (as described above) and other additives (such as pigment and/or filler as described above). At least one acrylate oligomer may be added together with the chain extender component to react with a prepolymer in order to form the polymer composition. Advantageously, formation is via a C-Michael addition, to provide a C-Michael polymer, as further described below.

The chain extender component used to form the polymer suitably comprises a low molecular compound having two or more active acrylic functions. Examples of such acrylic function containing compounds include the acrylate group consisting of hexafunctional urethane acrylates, dipentaerythritol pentaacrylate, ethoxylated pentaerythritol tetraacrylate, di-trimethylolpropane tetraacrylate, pentaerythritol triacrylate, trimethylolpropane triacrylate, ethoxylated trimethylolpropane triacrylate, butanediol diacrylate, tripropylene glycol diacrylate, trimethylolpropane trimethacrylate, difunctional urethane acrylates and tetraacrylate monomer.

The molar ratio of chain extender to acetoacetate end capped polyol of the first aspect of the invention employed is preferably in the range from 1 to 10:1, more preferably 1.5 to 8:1, particularly 2 to 5:1, and especially 2.5 to 4:1.

The present invention also provides a method of making a polymer composition comprising reacting said acetoacetate end-capped polyol with an acrylate to form:
(i) a polymer resin; or
(ii) a polymer matrix.

The preferred features of the acetoacetate end-capped polyol and the preferred features of the acrylate are as described above in relation to the composition embodiments.

Suitably, the method includes the step of forming i) a polymer resin, and then subsequently forming ii) a polymer matrix from the pre-formed resin. It is envisaged that the step of forming i) the polymer resin may be performed in one geographic location, and then the subsequent step of forming ii) the polymer matrix from the polymer resin may be performed in a second geographically distinct location.

The method of making the polymer composition may comprise mixing together the acetoacetate end-capped polyol with the acrylate. This is to ensure that the two reactants are brought into intimate proximity resulting in a homogenous polymer composition.

Suitably, the molar ratio of the acetoacetate end-capped polyol to acrylate reactants is in the range from between 1:0.2 to 4, preferably from between 1:0.25 to 3, more preferably from between 1:0.25 to 2.5, and most preferably from between 1:0.25 to 1.8.

As alluded to above, the main difference between the polymer composition resin and the polymer composition matrix, is the fact that the matrix is further processed to achieve cross-linking between the polymer chains. As such, in the method of making the polymer composition (ii) a polymer matrix the method must include the step of crosslinking the polymer chains. Methods of cross-linking polymer resins to provide polymer matrix are known in the art of polymer manufacturing and are generally referred to as methods of curing. In the present method the cross-linking of the polymer chains may be achieved by any suitable means. However, cross-linking via free radical polymerisation or via Michael addition reaction is particularly suitable.

The cross-linking via free radical polymerisation or via Michael addition reaction may be achieved at ambient temperature, and more desirably at room temperature. In particular, the cross-linking via free radical polymerisation or via Michael addition reaction may advantageously be achieved at a temperature between 0⁰ and 120° C., preferably at a temperature between 15° C. and 60° C., and more preferably at a temperature between 20° C. and 25° C.

More especially, cross-linking via Michael addition reaction is preferred; such materials can be referred to as Carbon-Michael reacted polymers, or C-Michael polymers for short. As such, the end-capped polyol containing polymer composition matrix product formed via this particularly preferred method may conveniently be referred to as a C-Michael polymer herein.

It is a significant advantage of the present invention that the cross linking (or curing) can be achieved by carbon cross-linking by way of a Michael addition reaction. The ability to utilise the Michael addition reaction method for achieving carbon to carbon bonds is facilitated by the presence of the acetoacetate end-capped polyol as described herein. The fact that the relatively mild method of achieving the carbon to carbon bonds can be utilised means that polymer manufacturing methods utilising isocyanate as a reactant can be replaced but unexpectedly without the loss of product performance when the polymer matrix is utilised in its intended end use as compared to polymers prepared utilising isocyanate. Such an isocyanate free method of polymer manufacture has clear health and environmental benefits over a traditional isocyanate polymer manufacturing method. Additionally, the fact that the Michael addition reaction may be achieved at ambient temperature and/or room temperature provides ease of manufacturing benefits.

The present invention further provides the use of an acetoacetate end-capped polyol as described herein to form a polymer composition. The polymer compositions, and more especially the C-Michael polymers, described herein may be used in many applications. The polymers of the present invention may preferably be used in coating compositions, adhesive compositions, sealant compositions or elastomer compositions. In particular, the polymers may find application in coatings, adhesives, elastomers, or sealants and more preferably in elastomers or sealants.

Additionally, the present invention provides a coating composition, adhesive compositions, sealant compositions or elastomer comprising the acetoacetate end-capped polyol described above. Preferably, there is provided adhesive compositions, sealant compositions or elastomer compositions comprising the acetoacetate end-capped polyol described above.

More especially, the preferred adhesive compositions, sealant compositions or elastomer compositions comprise a polymer composition matrix as described herein. Advantageously, the adhesive compositions, sealant compositions or elastomer compositions comprise a C-Michael polymer as described herein.

All of the features described herein may be combined with any of the above aspects, in any combination.

### EXAMPLES

The present invention will now be described further by way of example only with reference to the following Examples. All parts and percentages are given by weight unless otherwise stated.

It will be understood that all tests and physical properties listed have been determined at atmospheric pressure and room temperature (i.e. about 20° C.), unless otherwise stated herein, or unless otherwise stated in the referenced test methods and procedures.

Materials as used in the following examples are identified as follows:
Azelaic acid (C dicarboxylic acid)—a bio-based version as Crodacid DC1195 ex Croda
Pripol™ 1006 dimer fatty diacid—a hydrogenated C₃₆ dicarboxylic acid ex Croda
NEO POLYOL 240—rPET polyol ex NEOGROUP
PPG 1000—ex Sigma-Aldrich
Methyl acetoacetate—MAA ex Lonza
Photomer™ 3016—a acrylate ex IGM Resins
Photomer™ 4028—a acrylate ex IGM Resins
Nyad® 400—a wollastonite ex Imerys
Add-2272—a de-aeration agent ex ADD-additives
Aerosil 200—a fumed silica ex Evonik Industries.

Test methods:
Number average molecular weight was determined by end group analysis with reference to the hydroxyl value.
Weight average molecular weight was determined by end group analysis with reference to the hydroxyl value.
The hydroxyl value is defined as the number of mg of potassium hydroxide equivalent to the hydroxyl content of 1 g of sample and was measured by acetylation followed by hydrolysation of excess acetic anhydride. The acetic acid formed was subsequently titrated with an ethanolic potassium hydroxide solution.
The acid value is defined as the number of mg of potassium hydroxide required to neutralise the free fatty acids in 1 g of sample and was measured by direct titration with a standard potassium hydroxide solution.
Shore A Hardness was measured according to DIN 53505.
Elongation was measured using an Instron tensile tester according to ISO 37 using dumb-bell test pieces of type 2 unless otherwise specified.
Tensile Strength was measured using an Instron tensile tester according to ISO 37 using dumb-bell test pieces of type 2 unless otherwise specified.
Tear Strength was measured using an Instron tensile tester according to ISO 34-1 using method B unless otherwise specified.
Adhesive strength was tested according to ISO 4587.

### Example 1: Preparation and Examples of Acetoacetate End-Capped Polyols

P1—Dimer Fatty Acid and Containing Polyol

In a reactor equipped with a stirrer, a thermometer, a gas inlet and condenser, 100 parts by weight of Pripol 1006 and 200 parts NEOPOL 240, were charged. Subsequently, the temperature of the reactor was raised from ambient temperature to 220-230° C. under normal pressure under a nitrogen atmosphere. Under these conditions an esterification reaction was conducted to obtain a polyester polyol. The esterification reaction was conducted until the desired acid/hydroxyl value was observed; in this example the polyester polyol obtained had an acid value of less than 1 mg KOH/g and a hydroxyl value of 103 mg KOH/g. The polyester polyol obtained had a calculated number average molecular weight of about 1000 g/mol.

P2—Azelaic Acid, and rPET Polyol Containing Polyol

In a reactor equipped with a stirrer, a thermometer, a gas inlet, and condenser, 70 parts by weight of Crodacid DC1195 and 100 parts NEOPOLYOL 240, were charged. Subsequently, the temperature of the reactor was raised from ambient temperature to 220-230° C., under normal pressure in a nitrogen atmosphere. Under these conditions an esterification reaction was conducted until the desired acid/hydroxyl value was observed. In this example the polyester polyol obtained had an acid value of less than 1 mg KOH/g and a hydroxyl value of 112 mg KOH/g. The polyester polyol obtained had a calculated number average molecular weight of about 1000 g/mol.

General Method for Conversion to Acetoacetate End-Capped Polyol

Each of the polyester polyols and a comparative PPG-polyol prepared above were subsequently modified to render them acetoacetate end-capped, in accordance with the present invention.

In a reactor equipped with a stirrer, a thermometer, a gas inlet, and a condenser, 100 parts by weight of each of a polyol as prepared above and 25 parts by weight methyl acetoacetate (Lonza MAA) were charged.

The temperature of the reactor was raised to 150-160° C. under normal pressure in a nitrogen atmosphere. Under these conditions the reaction is continued until the theoretical amount of methanol distillate was achieved.

If necessary, a vacuum can be applied to ensure the completion of the reaction. Gel chromatography can be used to identify the reaction completion.

### Example 2: Preparation and Analysis of Elastomer/Sealant Containing the Example and Comparative Polyols

Various elastomer/sealant compositions were prepared as detailed in Table 1, below. A C-Michael addition reaction performed at room temperature was employed when utilising example acetoacetate end-capped polyol as described above available acrylate-based oligomers. The elastomer/sealant was prepared using a 2-component process. The C-Michael crosslinking achieved within the polymer matrix can be accelerated by the use of an organic base catalyst like DBU (1,8-diazabicyclo[5.4.0]undec-7-ene.) if desirable.

The acetoacetate end-capped polyol and acrylate based oligomer were reacted in a molar ratio of 1:1, as noted below in Table 1. The two commercially available acrylate based oligomers tested were Photomer™ 3016 (epoxy acrylate ex IGM Resins) and/or Photomer 4028 (acrylate ex IGM Resins). The resulting elastomer/sealant is therefore a 2 component based product but is advantageously prepared in the absence of isocyanate. The elastomer/sealant composition was casted in a mould for the mechanical properties evaluation including Shore A hardness, tensile strength, elongation and tear strength.

The Elastomer/Sealant Properties were Evaluated, and the Results are Given in Table 1 & 2

TABLE 1
Elastomer/sealant 2-component system in molar ratio

| | End-capped polyol | | | | | |
|---|---|---|---|---|---|---|
| | Elastomer/sealant composition (wt %) | | | | | |
| | Molar ratio | | | | | |
| | 1.3:1 | | | 1:1 | | |
| | Example | | | | | |
| | reference | 1 | 2 | reference | 1a | 2a |
| PPG | 58.9 | | | 51.8 | | |
| Polyol P1 | | 58.9 | | | 51.8 | |
| Polyol P2 | | | 58.9 | | | 51.8 |
| Photomer 4028 | 19.4 | 19.4 | 19.4 | 46.2 | 46.2 | 46.2 |
| Photomer 3016 | 19.4 | 19.4 | 19.4 | — | — | — |
| Catalyst DBU | 1.0 | 1.0 | 1.0 | 1.0 | 1.0 | 1.0 |
| ADD-2272 | 1.0 | 1.0 | 1.0 | 1.0 | 1.0 | 1.0 |

TABLE 2
Mechanical evaluation of the unfilled elastomer/sealant

| | refer- | | | refer- | | |
|---|---|---|---|---|---|---|
| | ence | 1 | 2 | ence | 1a | 2a |
| Shore A hardness | 50 | 60 | 59 | 62 | 45 | 65 |
| Tensile strength (MPa) | 0.6 | 2.6 | 4.4 | 0.9 | 0.8 | 2.0 |
| Elongation (%) | 50 | 72 | 75 | 29 | 112 | 103 |
| Tear strength (N/mm) | 3 | 8 | 10 | 2 | 4 | 5 |

When considering the mechanical detailed in Table 2, above, the C-Michael polymer matrix materials, which are formed at room temperature from an acetoacetate end-capped polyol of the present invention in combination with an acrylate oligomers, provide an elastomer or sealant that (when comparing the elastomer or sealant based on reference) provide a higher tensile strength, elongation, and improved tear strength without adversely affecting the Shore A hardness.

The more crystalline structure of example 2 enhances the tear strength over the more amorphous example 1. When combining the acetoacetate end-capped polyols of the present invention in combination with a single acrylate oligomer there is provided an elastomer/sealant that (when comparing the elastomer/sealant based on reference) provide a higher tensile strength, elongation, and improved tear strength without or only slightly effecting the Shore A hardness. The more crystalline structure of example 2a enhances the tear strength over the more amorphous example 1a.

TABLE 3
Elastomer or sealant filled 2-component
system in a 1.5:1 molar ratio

| | Elastomer/sealant composition |
|---|---|
| End-capped polyol | (wt %) |
| Molar ratio | 1.5:1 |

| | | |
|---|---|---|
| Example | 4 | 5 |
| Polyol P2 | 44 | 42.2 |
| Photomer 4028 | 7.6 | 25.4 |
| Photomer 3016 | 17.5 | — |
| Nyad 400 | 29.1 | 29.1 |
| Catalyst DBU | 1.0 | 1.0 |
| ADD-2272 | 1.0 | 1.0 |
| Aerosil 200 | — | 1.5 |

TABLE 4
Mechanical evaluation of the filled elastomer/sealant

| Example | 4 | 5 |
|---|---|---|
| Shore A hardness | 61 | 58 |
| Tensile strength (MPa) | 3 | 2 |
| Elongation (%) | 131 | 119 |
| Tear strength (N/mm) | 13 | 10 |

As can be seen from Table 4 above, that compositions comprising an acrylate oligomer blend including more than 20% and less than 40%, such as between 26 and 34% filler such as example 4 has high a higher tear, tensile strength and elongation when compared to a single use acrylate oligomer like example 5 at comparable Shore A hardness.

TABLE 5
Adhesive 2-component system in a 1:1 molar ratio

| | |
|---|---|
| End-capped polyol | Adhesive composition (wt %) |

| | | |
|---|---|---|
| Example | 6 | 7 |
| Polyol P2 | 100 | — |
| PPG | — | 100 |
| Photomer 4028 | 88 | 78 |
| Catalyst DBU | 1.8 | 1.8 |

Adhesive strength (MPa)

| | | |
|---|---|---|
| Example | 6 | 7 |
| Substrate | | |
| PP | 0.8 | 0.4 |
| PA | 1.0 | 0.6 |
| PVC | 2.2 | 1.5 |
| GFE^{*)} | 2.0 | 0.9 |
| Alu | 2.3 | 0.8 |
| Steel | 1.7 | 0.6 |

^{*)}Glass filled epoxy resin

When considering the adhesive strength detailed in Table 5 above, the C-Michael polymer matrix materials, which are formed at room temperature from the acetoacetate end-capped polyols of the present invention in combination with an acrylate oligomer, provide an adhesive formulation that is higher in adhesive strength than example 7. The adhesive strength given by the aromatic and semi crystalline structure of the acetoacetate end-capped polyol.

1. An acetoacetate end-capped polyol comprising at least one residue of a polyol derived from virgin thermoplastic polyester, recycled thermoplastic polyester and mixtures thereof.

2. The acetoacetate end-capped polyol of claim 1 further comprising:
a) at least one dimer fatty residue selected from a dimer fatty acid residue, a dimer fatty diol residue and a dimer fatty diamine residue;
and/or
b) at least one residue of a linear or branched C2 to C36 diacid or diol.

3. The acetoacetate end-capped polyol of claim 2 comprising
at least one residue of a linear or branched C2 to C36 diacid or diol.

4. The acetoacetate end-capped polyol of claim 3, wherein the weight ratio of a) to b) in the polyol is in the range of 45:55 to 15:85.

5. The acetoacetate end-capped polyol of claim 3 having a molecular weight (number average) of at least 500 and of at most 5000.

6. (canceled)

7. The acetoacetate end-capped polyol of claim 5, wherein the acetoacetate end-cap component of the acetoacetate end-capped polyol is selected from one or more of the following: methyl acetoacetate, ethyl acetoacetate, tert-butyl acetoacetate, isopropyl acetoacetate, isobutyl acetoacetate and ketene derivatives.

8. (canceled)

9. (canceled)

10. The acetoacetate end-capped polyol of claim 5, wherein said at least one residue of a polyol derived from virgin thermoplastic polyester, recycled thermoplastic polyester and mixtures thereof, is derived from polyethylene terephthalate.

11. (canceled)

12. (canceled)

13. The acetoacetate end-capped polyol of claim 5, comprising at least 10 wt % dimer fatty residue.

14. (canceled)

15. The acetoacetate end-capped polyol of claim 13, comprising at least one dimer fatty residue selected from a dimer fatty acid residue which is derived from the dimerisation products of oleic acid, linoleic acid, linolenic acid, palmitoleic acid, or elaidic acid.

16. (canceled)

17. The acetoacetate end-capped polyol of claim 5, wherein component b) comprises at least one residue of a linear dicarboxylic acid having a carbon chain in the range from 4 to 12 carbon atoms.

18. The acetoacetate end-capped polyol of claim 17, wherein component b) comprises at least one residue of a linear dicarboxylic acid derived from adipic acid, glutaric acid, succinic acid, pimelic acid, suberic acid, azelaic acid, sebacic acid, heptane dicarboxylic acid, octane dicarboxylic acid, nonane dicarboxylic acid, decane dicarboxylic acid, undecane dicarboxylic acid, and dodecane dicarboxylic acid.

19. The acetoacetate end-capped polyol of claim 18, wherein component b) comprises at least one residue of a linear dicarboxylic acid derived from azelaic acid.

20. A polymer composition comprising an acetoacetate end-capped polyol in accordance with claim 1.

21. (canceled)

22. (canceled)

23. The polymer composition of claim 20, wherein the polymer composition does not contain isocyanate.

24. The polymer composition of claim 20, wherein the polymer composition comprises said acetoacetate end-capped polyol and an acrylate.

25. The polymer composition of claim 24, wherein said acrylate may be selected from one or more of an acrylate, a polyfunctional acrylate, an oligomeric acrylate, or derivatives thereof.

26. The polymer composition of claim 24, wherein the polymer composition comprises one or more other additives selected from blowing agents, catalysts, pigments or dyes, fillers, surfactants, and stabilisers.

27. (canceled)

28. (canceled)

29. (canceled)

30. (canceled)

31. (canceled)

32. (canceled)

33. (canceled)

34. (canceled)

35. (canceled)

36. (canceled)

37. A coating composition, adhesive composition, sealant composition or elastomer composition comprising an acetoacetate end-capped polyol of claim 1.

38. A coating composition, adhesive composition, sealant composition or elastomer composition comprising an acetoacetate end-capped polyol of claim 5.
